(19) United States
(12) Patent Application Publication
(10) Pub. No.: US 2005/0256959 A1
(43) Pub. Date: Nov. 17, 2005

(54) Method of and system for multimedia messaging system interoperability

(76) Inventors: Magnus Svensson, Lomma (SE); Marcel Wong, Lund (SE); Fredrik Wendel, Lund (SE)

Correspondence Address: JENKENS & GILCHRIST, A PROFESSIONAL CORPORATION;Stanley R. Moore, 1445 Ross Avenue, Suite 3200, Dallas, TX, 75202, US

(21) Appl. No.: 10/823,275

(22) Filed: Apr. 13, 2004

(51) Int. Cl. G06F 15/16

(52) U.S. Cl. 709/228

(57) ABSTRACT

A multimedia-messaging-capability-negotiation method includes receiving, by a first service, of multimedia-messaging-capability information from a receiving client. The multimedia-messaging-capability information is transmitted by the first service to a sending client. The multimedia-messaging-capability information is evaluated by the sending client in order to determine what further action to take relative to communicating with the receiving client. This Abstract is provided to comply with rules requiring an Abstract that allows a searcher or other reader to quickly ascertain subject matter of the technical disclosure. This Abstract is submitted with the understanding that it will not be used to interpret or limit the scope or meaning of the claims.

### TECHNICAL FIELD

The present invention relates to multimedia communications, and more particularly, but not by way of limitation, to multimedia messaging service (MMS) interoperability between an MMS sending client and an MMS receiving client.

### HISTORY OF RELATED ART

MMS is a service that allows users to send messages with multimedia content such as, for example, pictures, text, or music, between mobile telephones or other devices (clients). MMS allows many different kinds of multimedia content to be transmitted; therefore, the capability of the clients is the primary limitation on what type of multimedia content can be transmitted and received. The flexibility in types of multimedia content that may be transmitted and received, however, sometimes results in a sending client transmitting multimedia content that a receiving client is not able to render. In such situations, air traffic is wasted.

In current systems, a mechanism is specified by MMS that informs an MMS service of the multimedia capabilities of the receiving client. The MMS service is tasked with performing an adaptation (i.e., conversion) of the multimedia content transmitted by the sending client so that the receiving client is able to properly render the multimedia content transmitted. Adaptation by the MMS service works acceptably in some situations, such as, for example, adaptation of image resolutions. However, the adaptation by the MMS service does not work well when, for example, a given multimedia content type is not supported at all by the receiving client, such as when the sending client transmits a video clip and the receiving client does not support video at all.

Even though MMS is very flexible, it raises interoperability concerns. For example, it is not always possible to convert all kinds of multimedia content on the MMS server; therefore, the multimedia content transmitted by the sending client is, in such situations, not presented to the receiving client and air traffic is wasted.

### SUMMARY OF THE INVENTION

The present invention relates to multimedia communications. More particularly, one aspect of the invention relates to a method of multimedia-messaging-capability-negotiation that includes a plurality of steps. The multimedia-messaging-capability-negotiation method includes receiving, by a first service, of multimedia-messaging-capability information from a receiving client and transmitting, by the first service, of the multimedia-messaging-capability information to a sending client. The multimedia-messaging-capability information is evaluated by the sending client in order to determine what further action to take relative to communicating with the receiving client.

In yet another aspect, an embodiment of the invention includes an end-to-end multimedia-messaging-capability-negotiation system. The end-to-end multimedia-messaging-capability-negotiation system includes a WV service and an MMS service. The WV service is adapted to receive multimedia-messaging-capability information from a receiving client and transmit the multimedia-messaging-capability information to a sending client. The MMS service is adapted to transmit a message from the sending client to the receiving client. The message is adapted by the sending client in accordance with the multimedia-messaging-capability information.

### BRIEF DESCRIPTION OF THE DRAWINGS

A more complete understanding of the present invention may be obtained by reference to the following Detailed Description of Exemplary Embodiments of the Invention, when taken in conjunction with the accompanying Drawings, wherein:

FIG. 1 is a block diagram that illustrates sending of a multimedia message from a sending client to a receiving client following end-to-end capability negotiation;

FIG. 2 illustrates an operational flow from the perspective of an MMS sending client; and

FIG. 3 illustrates an MMS-sending-client decision flow.

### DETAILED DESCRIPTION OF EXEMPLARY EMBODIMENTS OF THE INVENTION

Embodiment(s) of the invention will now be described more fully with reference to the accompanying Drawings. The invention may, however, be embodied in many different forms and should not be construed as limited to the embodiment(s) set forth herein. The invention should only be considered limited by the claims as they now exist and the equivalents thereof.

MMS is a store-and-forward messaging service that allows users of clients to exchange multimedia messages with other users of clients. MMS may be viewed as an evolution of SMS, with MMS supporting the transmission of additional media types, including text, picture, audio, video, and combinations of these additional media types. MMS allows the sending of multimedia in a single message and the ability to send a message to multiple recipients.

MMS service providers must serve a large number of clients that may have vastly different features. Users of the clients typically have access to a large number of services with a wide variety of multimedia content. A user agent profile (UAprof) is an eXtensible-Markup-Language-formatted (XML-formatted) document that may be published on a public repository server on, for example, an MMS service. The UAprof provides client-capability information that may be used for content-formatting purposes. The UAprof is intended to enable a better fit between content and the capabilities of the client. The UAprof also permits retrieval of the most suitable content for a specific client and adaptation of the content to the capabilities of the client. The UAprof currently used in MMS may include information related to a hardware platform, software platform, browser user agent, network characteristics, Wireless Application Protocol (WAP) characteristics, and push characteristics of a given client.

In MMS, content adaptation is performed at a server after the UAprof has been obtained from a repository or local cache. A WAP gateway or HyperText Transfer Protocol (HTTP) proxy may be used to perform the content adaptation. The content may be adapted to capabilities of the client by, for example, scaling a bit map, adjusting a color map of an image to fit a display of the receiving client, or reducing the size of an image or music file via re-sampling.

In order to achieve better performance than that of current systems using MMS, end-to-end capability negotiation is achieved via various embodiments of the invention. If the sending client is able to ascertain the capabilities of the receiving client before a multimedia message is composed or sent, the waste of air traffic that can occur with MMS-service adaptation can be avoided. For example, the sending client could display to a user that particular messaging options are not supported by the receiving client by displaying the non-supported options in a greyed-out (i.e., non-user-selectable) format.

The Wireless Village protocol (WV) may be used for the end-to-end capability negotiations. WV is an instant-messaging protocol that has already been implemented in some mobile telephones and other devices and is expected to be widely deployed in the near future. Mechanisms in WV permit the receiving client to publish instant-messaging capabilities of the receiving client. However, WV does not currently provide for publication by the receiving client of the multimedia-messaging capabilities of the receiving client.

Presence attributes are utilized by WV to maximize interoperability between manufacturers. Generally speaking, a presence attribute contains presence information intended for the user of the client. The presence attribute may also contain meta-information for machine-to-machine communications. The presence attributes may be divided into the following classes: (1) client status; (2) user status; and (3) extended presence information. Client status refers to presence attributes describing the availability of the client for communication, location information, and capabilities of the client. User status refers to presence attributes describing the availability of the user for communication, personal user status, and user information. Extended presence information refers to vendor-specific or service provider dynamically defined non-standard presence attributes that need to be passed through standard presence servers and also includes extension fields to standard presence attributes.

In accordance with principles of various embodiments of the invention, the ability of the receiving client to use the Wireless Village protocol to publish the instant-messaging capabilities of the receiving client may be extended in order to permit the receiving client to publish the multimedia-messaging capabilities of the receiving client. Interoperability between the sending client and the receiving client are thus improved, which provides users of the sending client and the receiving client a better service experience, avoids unnecessary air traffic, and permits a greater percentage of MMS messages to be charged by a service provider, since every MMS message that is sent by the sending client reaches the receiving client and can therefore be charged.

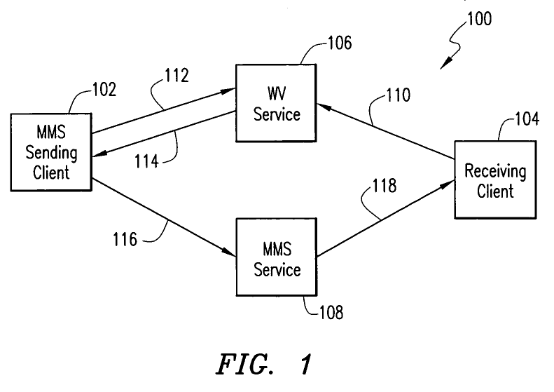

Referring now to the FIGURES, in FIG. 1 is shown a block diagram that illustrates sending of a multimedia message from a sending client to a receiving client following end-to-end capability negotiation. In FIG. 1, a system 100 includes an MMS sending client 102, a receiving client 104, a WV service 106, and an MMS service 108. The MMS sending client 102 is capable of sending multimedia messages in accordance with MSS. The receiving client 104 may or may not be capable of receiving multimedia messages in accordance with MMS, as described in more detail below.

In FIG. 1, the receiving client 104 transmits a multimedia-messaging publication message 110 to the WV service 106. The multimedia-messaging publication message 110 publishes information regarding the multimedia-messaging capabilities of the receiving client 104 to the WV service 106. Upon receipt of the multimedia-messaging capability information from the receiving client 104, the WV service 106 saves the multimedia-messaging capability information regarding the receiving client 104. It will be appreciated by those having ordinary skill in the art that each of the WV service 106 and the MMS service 108 may reside on individual servers or multiple servers, and also that the WV service 106 and the MMS service 108 may reside, in whole or in part, on the same server or servers.

If the MMS sending client 102 wants to send a multimedia message to the receiving client 104, the MMS sending client 102 submits an MMS capability query 112 relative to the receiving client 104 to the WV service 106. The MMS capability query 112 may be activated manually by a user of the MMS sending client 102 or may be automatically performed automatically by the MMS sending client 102 after the user of the MMS sending client has composed a multimedia message.

In response to the MMS capability query 112, the WV service 106 transmits an MMS capability reply 114 relative to the receiving client 104 to the MMS sending client 102. The MMS capability reply 114 provides information relative to the multimedia messaging capability of the receiving client 104 to the MMS sending client 102.

After the MMS sending client 102 has obtained the multimedia messaging capability information relative to the receiving client 104 from the MMS capability reply 114, the MMS sending client 102 is prepared to send a message to the receiving client 104. As indicated above, depending on the multimedia-messaging capability of the receiving client, the MMS sending client 102 may send the message as an MMS message, send the message as an Short Message Service (SMS) message, send no message at all, or take some other action. Although a user of the MMS sending client 102 may choose the type of message content to be sent from the MMS sending client 102 to the receiving client 104, the user need not necessarily have any interaction in this regard, in which case the MMS sending client 102 would contain the necessary intelligence to choose the appropriate course of action in response to information contained in the MMS capability reply 114.

If it is assumed that the receiving client 104 is capable of receiving the message as an MMS message, the MMS sending client 102 next sends an MMS message 116 to the MMS service 108. Upon receipt of the MMS message 116, the MMS service 108 forwards an MMS message 118 to the receiving client 104.

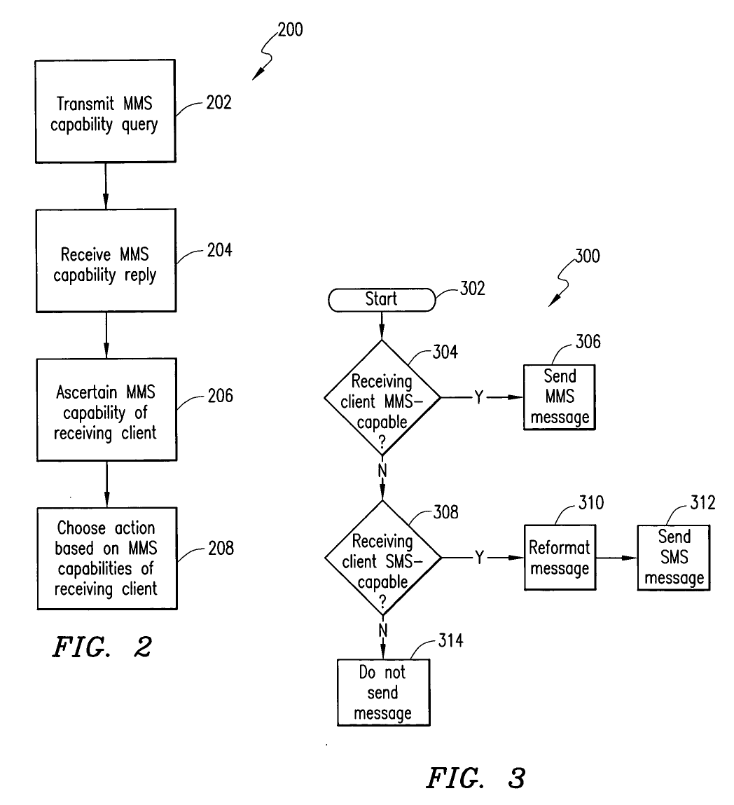

Referring again to the FIGURES, FIG. 2 illustrates an operational flow from the perspective of the MMS sending client 102. A flow 200 begins at step 202. At step 202, the MMS sending client 102 transmits the MMS capability query 112. From step 202, execution proceeds to step 204. At step 204, the MMS sending client 102 receives the MMS capability reply 114. From step 204, execution proceeds to step 206. At step 206, the MMS sending client 102 ascertains the MMS capabilities of the receiving client 104 from the MMS capability reply 114 received at step 204. From step 206, execution proceeds to step 208. At step 208, the MMS sending client 102 chooses an appropriate action based upon the MMS capabilities of the receiving client 104 ascertained by the MMS sending client 102 at step 206.

In various embodiments of the invention, intelligence that is typically found in the MMS service 108 is ported to the MMS sending client 102. The MSS sending client 102 is then able to access information about the multimedia-messaging capabilities of the receiving client 104 from information published by the receiving client 104 to the WV service 106. After the capabilities of the receiving client 104 have been ascertained by the MMS sending client 102, the MMS sending client 102 may take appropriate action(s). The appropriate action(s) taken by the MMS sending client 102 may include, for example, sending the message in its current form, modifying the message to a form that is suitable to the receiving client 104, or not sending the message at all.

Referring again to FIGURES, FIG. 3 illustrates an MMS-sending-client decision flow. A decision flow 300 is typically executed at steps 206 and 208 of the flow 200. In other words, the flow 300 represents a more-detailed example of ascertainment of the MMS capabilities of the receiving client 104 and choosing of an appropriate action based on those MMS capabilities.

The flow 300 begins at step 302. From step 302, execution proceeds to step 304. At step 304, the MMS sending client 102 determines whether the receiving client 104 is MMS-capable. If it is determined at step 304 that the receiving client 104 is MMS-capable, execution proceeds to step 306. At step 306, the MMS sending client 102 sends the MMS message 116.

If, however, at step 304, it is not determined that the receiving client 104 is MMS-capable, execution proceeds to step 308. At step 308, it is determined whether the receiving client 104 is SMS-capable. If, at step 308, it is determined that the receiving client 104 is SMS-capable, execution proceeds to step 310. At step 310, the MMS message originally to be sent by the MMS sending client 102 is reformatted as an SMS message. From step 310, execution proceeds to step 312. At step 312, the SMS message resulting from step 310 is sent. If, at step 308, it is not determined that the receiving client 104 is SMS-capable, execution proceeds to step 314. At step 314, the MMS sending client 102 does not send a message at all.

The multimedia-messaging capability information contained in the multimedia-messaging capability message 110 may be published to the WV service 106 in an least the following six different ways: (1) via WV extension fields for presence attributes for the receiving client 104; (2) via a user agent profile (UAprof) link in a client information presence attribute of the receiving client 104; (3) via a UAprof element added to a client information element of the receiving client 104; (4) via a UA link presence attribute extension; (5) via a UAprof element presence attribute extension; and (6) via a proprietary defined capability element. Although six exemplary ways are mentioned above, other ways to publish the multimedia-messaging capability information of the receiving client 104 may be used without departing from principles of the invention.

The previous Detailed Description is of embodiment(s) of the invention. The scope of the invention should not necessarily be limited by this Description. The scope of the invention is instead defined by the following claims and the equivalents thereof.

1. A multimedia-messaging-capability-negotiation method comprising:
receiving, by a first service, of multimedia-messaging-capability information from a receiving client;
transmitting, by the first service, of the multimedia-messaging-capability information to a sending client; and
evaluating the multimedia-messaging-capability information by the sending client in order to determine what further action to take relative to communicating with the receiving client.

2. The method of claim 1, further comprising:
transmitting, by a second service, of a message from the sending client to the receiving client; and
wherein the message is adapted by the sending client in accordance with the multimedia-messaging-capability information.

3. The method of claim 1, further comprising opting, by the sending client, to not send a message to the receiving client.

4. The method of claim 2, wherein the second service operates in accordance with multimedia messaging services (MMS).

5. The method of claim 1, wherein the first service operates in accordance with Wireless Village protocol (WV).

6. The method of claim 2, wherein:
the first service operates in accordance with WV; and
the second service operates in accordance with MMS.

7. The method of claim 1, wherein the multimedia-messaging-capability information indicates that the receiving client is adapted to receive multimedia messages.

8. The method of claim 7, wherein the message is in accordance with MMS.

9. The method of claim 1, wherein the multimedia-messaging-capability information indicates that the receiving client is not adapted to receive multimedia messages.

10. The method of claim 9, wherein the message is in accordance with short messaging service (SMS).

11. The method of claim 1, wherein the multimedia-messaging-capability information is included in a WV extension field for presence attributes for the receiving client.

12. The method of claim 1, wherein the multimedia-messaging-capability information is included in a user agent profile (UAprof) link in an information presence attribute of the receiving client.

13. The method of claim 1, wherein the multimedia-messaging-capability information is included in a UAprof element of a client information element of the receiving client.

14. An end-to-end multimedia-messaging-capability-negotiation system comprising:
a WV service, wherein the WV service is adapted to:
receive multimedia-messaging-capability information from a receiving client; and
transmit the multimedia-messaging-capability information to a sending client;
an MMS service, wherein the MMS service is adapted to transmit a message from the sending client to the receiving client; and
wherein the message is adapted by the sending client in accordance with the multimedia-messaging-capability information.

15. The end-to-end multimedia-messaging-capability-negotiation system of claim 14, wherein the sending client may, responsive to receipt of the multimedia-messaging-capability information, opt to not send a message to the receiving client.

16. The end-to-end multimedia-messaging-capability-negotiation system of claim 14, wherein the multimedia-messaging-capability information indicates that the receiving client is adapted to receive multimedia messages.

17. The end-to-end multimedia-messaging-capability-negotiation system of claim 14, wherein the multimedia-messaging-capability information indicates that the receiving client is not adapted to receive multimedia messages.

18. The end-to-end multimedia-messaging-capability-negotiation system of claim 17, wherein the message is in accordance with SMS.

19. The end-to-end multimedia-messaging-capability-negotiation system of claim 14, wherein the multimedia-messaging-capability information is included in a WV extension field for presence attributes for the receiving client.

20. The end-to-end multimedia-messaging-capability-negotiation system of claim 14, wherein the multimedia-messaging-capability information is included in a UAprof link in an information presence attribute of the receiving client.

21. The end-to-end multimedia-messaging-capability-negotiation system of claim 14, wherein the multimedia-messaging-capability information is included in a UAprof element of a client information element of the receiving client.
